(19) United States
(12) Patent Application Publication
(10) Pub. No.: US 2011/0233248 A1
(43) Pub. Date: Sep. 29, 2011

(54) Carrier Device For Attaching To A Pane Of A Motor Vehicle

(75) Inventors: André Flemming, Gaertringen (DE); Martin Krug, Karlsruhe (DE); Norbert Schloemer, Emstek (DE); Juergen Seekircher, Ostfildern (DE)

(73) Assignee: Daimler AG, Stuttgart (DE)

(21) Appl. No.: 13/122,437

(22) PCT Filed: Sep. 24, 2009
(86) PCT No.: PCT/EP2009/006896

§ 371 Date: Jun. 17, 2011

(30) Foreign Application Priority Data
Oct. 4, 2008 (DE) 10 2008 050 320.7

(51) Int. Cl. B60R 7/00

(52) U.S. Cl. 224/482

(57) ABSTRACT

A carrier device for attaching to a pane, particularly a windshield, of a motor vehicle is provided. The carrier device has a carrier plate that can be attached to the pane, which is made of plastic at least in segments, and by which at least one camera, a sensor or the like is carried, wherein the plastic of the carrier plate is permeated with an additive material, particularly a glass additive material.

### CROSS-REFERENCE TO RELATED APPLICATIONS

The present application is a national stage of PCT International Application No. PCT/EP2009/006896, filed Sep. 24, 2009, and claims priority under 35 U.S.C. §119 to German Patent Application No. 10 2008 050 320.7, filed Oct. 4, 2008, the entire disclosures of which afore-mentioned documents are herein expressly incorporated by reference.

### BACKGROUND AND SUMMARY OF THE INVENTION

The invention relates to a carrier device for attaching to a pane, in particular a windshield, of a motor vehicle.

DE 103 28 468 A1 discloses a carrier device including a carrier plate that can be attached to a pane of a motor vehicle, which is made of plastic at least in segments, and by which at least a camera, a sensor or the like is carried.

It is an object of the present invention to create a carrier device of the type mentioned above, which can be attached to the pane in a particularly favorable manner even with different vehicles.

This object is achieved with a carrier device according to the present invention. Advantageous arrangements with convenient and non-trivial further developments of the invention are also provided.

In order to create a carrier device of the type mentioned above, which can be arranged even with different vehicles at its pane in a particularly favorable manner, it is provided according to the invention that the plastic carrier plate is permeated with an additive material, particularly a glass additive material. In other words, it is provided according to the invention to use a plastic for the carrier plate at least in segments, which has an added fiber material or the like. By the addition of this material it can be achieved that with a considerable heating as a result of sun radiation, for example, different expansions of the pane, which usually consists of a glass material, and the carrier plate, can be reduced correspondingly or balanced. It has thus been shown to be particularly advantageous to use a glass additive material which has such properties that the material expansions of the pane of the carrier plate are at least approximately similar. As a result, a particularly favorable fixing of the carrier plate at the pane can be realized by means of the help of a conventional adhesive such as a PU adhesive.

In a further arrangement of the invention it has furthermore been shown to be advantageous if the carrier plate comprises at least one expansion joint. By means of such an expansion joint, an expansion occurring with a corresponding heating of the carrier plate relative to the pane can be compensated in an improved manner.

It has further been shown to be advantageous if the carrier plate has at least one spacer on the side facing the pane. A particularly even and reproducible fixing of the carrier plate at the pane is achieved thereby, in particular, if a corresponding adhesive is used.

It is additionally advantageous if the carrier plate is permeated by at least one venting opening. By means of such a venting opening, air bubbles are in particular prevented when adhering the carrier plate.

It is further advantageous if the carrier plate has at least one recess, which is formed as a face plate for an associated camera. The carrier plate thus has the further function of a face plate, so that a separate component can be foregone. The recess of the carrier plate forming the face plate thereby may have a border, which projects in an elevated manner with regard to the side facing the pane. By means of this border projecting in an elevated manner, the border abuts directly at its surface after the adhering, so that an effective dust protection is achieved.

The carrier plate has a carrying device serving as a stop in a further arrangement, against which the camera, the sensor or the like can be supported with a force directed from the carrier plate in the direction of the interior of the motor vehicle. With this arrangement, a particularly advantageous tolerance chain and a position-exact arrangement of the camera, the sensor or the like is achieved.

It is additionally advantageous if the force supporting the camera, the sensor or the like against the carrying device can be applied by means of a spring device arranged at the carrier plate. By means of this spring arrangement, an even force is always applied, which keeps the camera in its position in a reliable manner.

A cover has further been shown to be advantageous, by means of which the at least one camera, the sensor or the like can be covered and which is arranged at the carrier plate in a relatively adjustable manner. By means of the adjustability of the cover relative to the carrier plate, tolerances from vehicle to vehicle can be balanced in a very favorable manner, so that, for example, the cover is always connected to a vehicle roof liner of the vehicle in a flush manner.

For adjusting the cover relative to the carrier plate, respective guide elements are arranged at the two cooperating components in a further arrangement, wherein the adjustment of the two components relative to each other can alternatively take place in a stepped or even stepless manner. A particularly simple and position-safe adjustment is thereby enabled by the guide elements.

In a further arrangement of the invention, the cover has a face plate. A separate face plate can thus be forgone, so that altogether a carrier device with very few components—namely essentially only the carrier plate and the cover—can be realized. The cover may be thereby provided with a coating at least partially, in order to create a particularly favorable protection against diffractive light.

A pane heater has further been shown to be advantageous, which is integrated into the carrier device. A region of the pane in front of the carrier device can be heated hereby in a simple manner, in order to avoid a misting of the pane.

It is furthermore advantageous if the additive material which is added to the plastic has reinforcing fibers and, particularly, glass fibers. This additive material can alternatively also comprise glass beads or the like. Glass material has been proven to be particularly advantageous, as this has at least essentially identical properties with the pane of the motor vehicle, so that an approach of the expansion coefficients of the plastic and the pane is possible. A plastic, which is low in expansion, may be used, which has an expansion behavior that is as similar as possible to the expansion behavior of the windscreen. Thus, the plastic may have a lot of glass fiber or glass beads, e.g., PBT GF 30 or PBT GB 20.

It has thereby been shown to be particularly advantageous if the part of the additive material or glass material is in a region of 10% to 40%, and in particular of 20% to 30%.

Further advantages, characteristics and details of the invention result from the following description of preferred embodiments and by means of the drawings.

### BRIEF DESCRIPTION OF THE DRAWING FIGURES

FIG. 1 illustrates a perspective in section of the carrier device arranged at a windshield for a plurality of cameras, sensors or the like, wherein a cover of the carrier device can presently be seen,

FIG. 2 illustrates a perspective in section of the carrier device according to FIG. 1 with a removed cover, wherein a carrier plate can be seen, by means of which the plurality of cameras, sensors or the like is carried, and which is attached to the interior of the pane by means of an adhesive;

FIG. 3 illustrates a perspective of the carrier plate according to FIG. 2, wherein the cameras, sensors or the like are omitted for clarity;

FIG. 4 illustrates a further perspective of the carrier plate according to FIG. 3, namely on the side of the carrier plate facing the windshield;

FIG. 5 illustrates a perspective in section of the arrangement of the carrier arrangement according to FIGS. 1 and 2, wherein the cover and the cameras, sensors or the like are omitted for clarity;

FIG. 6 illustrates a perspective in section of the windshield and the carrier device arranged behind from the outside;

FIG. 7 illustrates a perspective in section of the arrangement of the carrier device from the inside according to a second embodiment;

FIG. 8 illustrates a perspective in section of the carrier device from the inside with omitted cover, wherein cameras, sensors or the like held by the carrier plate can be seen in particular;

FIG. 9 illustrates a perspective of the carrier plate of the carrier device according to FIGS. 7 and 8;

FIG. 10 illustrates a perspective of the side of the carrier plate facing the pane according to FIG. 9;

FIG. 11 illustrates a perspective in section of the carrier plate of the carrier device adhered to the inner side of the windshield according to FIGS. 7 and 8;

FIG. 12 a perspective of the cover of the carrier plate according to FIG. 7; and

FIG. 13 a perspective of the inner side of cover according to FIG. 12.

### DETAILED DESCRIPTION OF THE DRAWING FIGURES

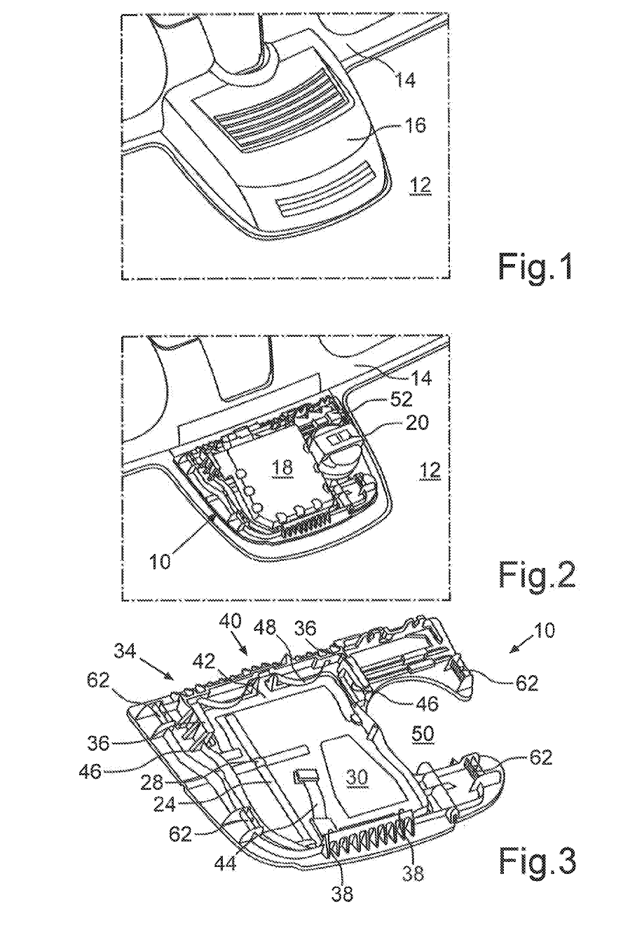

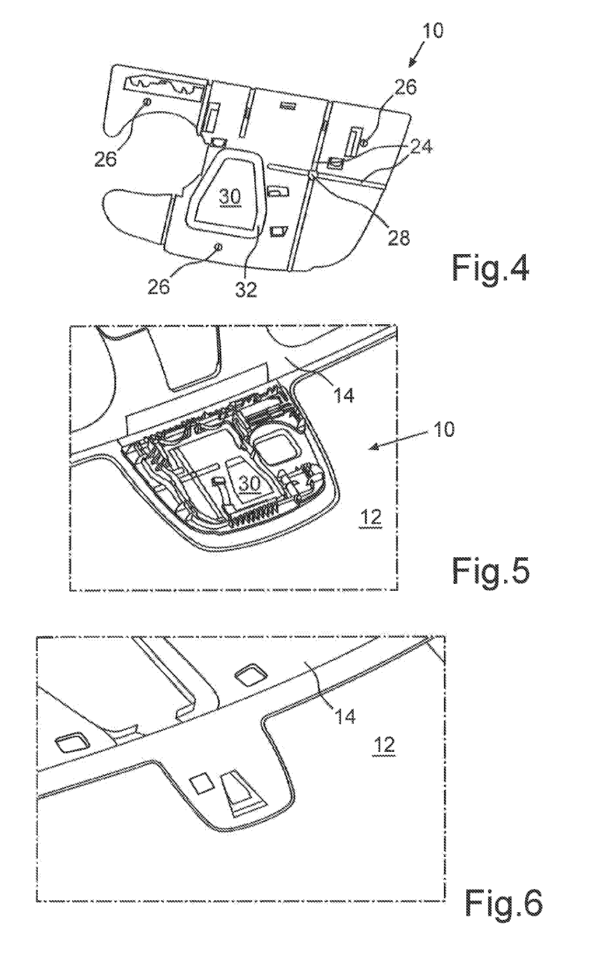

FIGS. 1 to 6 show a first embodiment of the carrier device. FIGS. 1, 2 and 5 thereby show the arrangement of the carrier device respectively from the vehicle interior. FIGS. 3 and 4 show a separate carrier plate 10 explained in more detail in the following, which is adhered on the inside at a windshield 12 that can be seen in FIGS. 1, 2 and 5 explained in more detail in the following, in the transfer region of the windshield 12 to a vehicle roof liner 14. FIG. 6 shows the arrangement of the carrier device in a view from the outside to the windshield 12 or the vehicle roof liner 14.

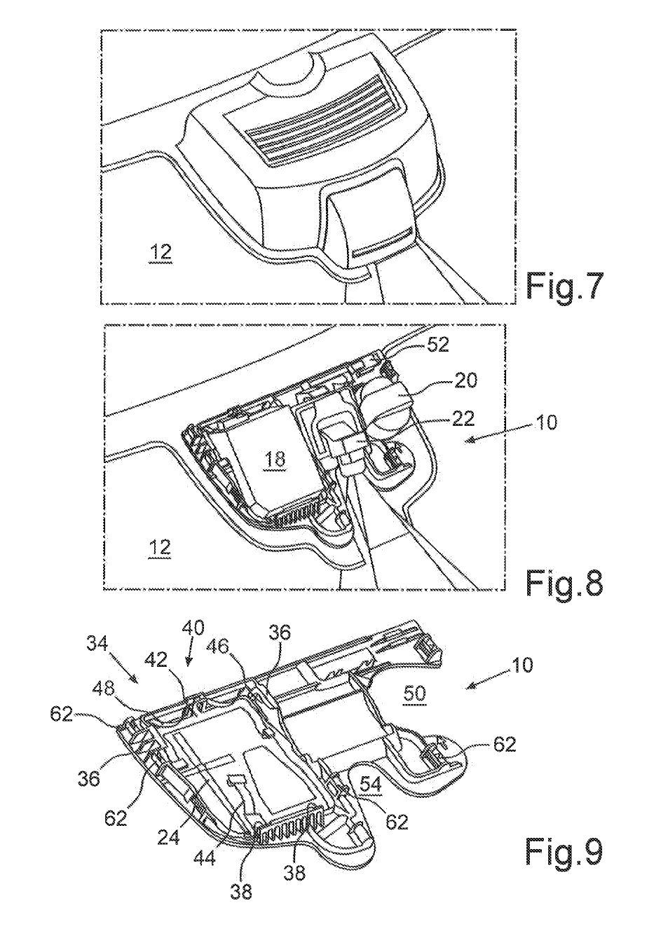

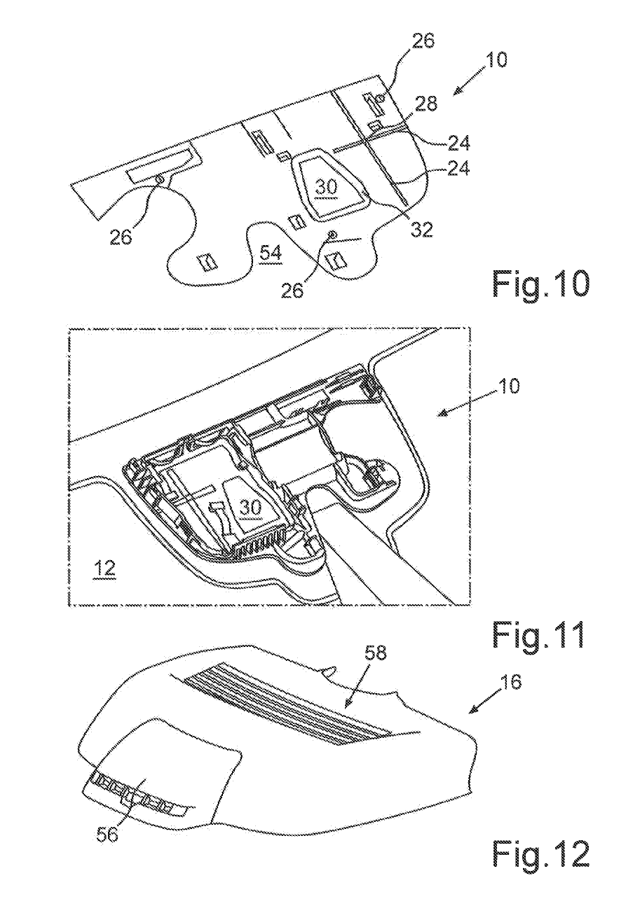

FIGS. 7 to 13 show a second embodiment of the present carrier device, which is distinguished from the first embodiment in that an additional camera is provided, which is explained in more detail below. FIGS. 7 and 8 thereby show—analogously to FIGS. 1 and 2—the arrangement of the carrier device at the windshield 10 from the interior of the motor vehicle, namely in the transfer region to the vehicle roof liner 14. FIGS. 9 and 10 show a second embodiment of the carrier plate 10 in a respective perspective, wherein the carrier plate is largely formed identical to the one according to FIGS. 3 and 4.

FIG. 11 shows the arrangement of the carrier plate 10 while applying an adhesive at the windshield 12 from the inside.

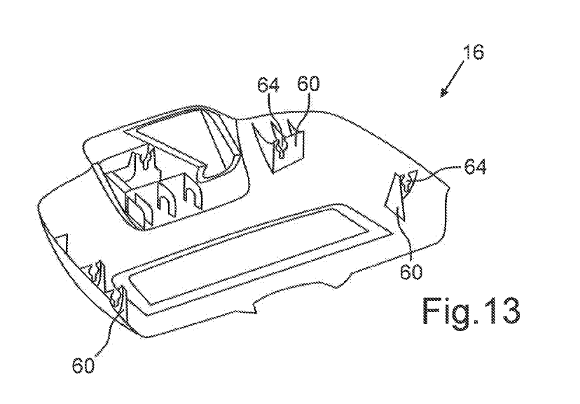

FIGS. 12 and 13 show a cover 16 of the carrier device according to the second embodiment (FIGS. 7 to 13) in a respective perspective.

As essential basic function coincides with both embodiments and thus they are described together in the following or are provided with identical reference numerals.

The carrier devices according to both embodiments thereby first comprise the cover 16, which closes the carrier device to the vehicle interior side. If this cover is removed, a view on the carrier device is essentially released, as can be seen in FIGS. 2 and 8. In FIGS. 2 and 8, a multiple use camera 18 is provided with the respective embodiment, which can be used, for example, as a lane keeping device, a traffic sign recognition or as a parking aid. A rain and light sensor 20 is further carried with both embodiments, via which rain or light for controlling the windshield wiper system, the air conditioning system and the vehicle lighting may be used.

In contrast to the embodiment according to FIGS. 1 to 6, a further camera 22 is provided, which is presently used for a night view system. It is obvious to the expert that an additional number of components, in particular cameras and sensors can be provided. The arrangement of the cameras and sensors can also be varied as their use for different purposes.

In order to now align the view on the respective carrier plate 10 according to FIGS. 3 and 4 or FIGS. 9 and 10, it has to be noted first that the carrier plate 10 respectively consists of a plastic with an additive material, in particular a glass material. This glass material can contain, for example, a glass fiber or glass beads, wherein the additive material is, for example, a part of 10% to 40%, and in particular from 20% to 30% with regard to the entire plastic. This additive material ensures that the carrier plate 10 obtains similar expansion properties or a similar expansion coefficient as the windshield 12. If the windshield 12 thus heats or the carrier plate 10 in the interior of the motor vehicle, the two parts roughly expand evenly correspondingly. This results in a favorable attachment of the carrier plate at the windshield 12. A particularly reliable and even arrangement of the cameras and sensors 18 to 22 is thus achieved, which has a positive effect on its measuring and sensing results. In order to adjust the camera angle correctly in the vehicle-specific manner, a differently formed carrier plate 10 respectively in the camera reception is possible from construction series to construction series. The basic construction thus does not have to change.

Furthermore, a plurality of expansion joints 24 can be seen with both embodiments on the side of the carrier plate facing the windshield 12, which proceed in a partially crossed manner. These expansion joints 24 are formed as grooves in the present case, which are introduced into the carrier plate 10 from the side facing the windshield 12. By means of these expansion joints 24, a particularly favorable arrangement of the carrier plate 10 at the windshield 12 is achieved. In order to be able to balance the mechanical tensions remaining in the plate 10, the different expansion joints 24 are thus arranged in the Y position and vertical thereto.

It can additionally be seen from FIGS. 3 and 4 or 9 and 10 that a plurality of spacers 26 are formed at the side facing the windshield 12, which are supported at the surface of the windscreen 12 an the arranged position of the carrier plate 10. The carrier plate 10 is thereby fixed at the windshield 12 for example by a PU adhesive or another adhesive, which is as elastic as possible, wherein the knob-like spacers 26 give an exact spacing of the carrier plate 10. The spacer which is as elastic as possible thereby provides a balance of expansions between the windshield 12 and the carrier plate 10 which are possibly still different. At least 3 spacers (a height of about 1 mm) may be used, in order to achieve an even thickness of the adhesive. The larger the thickness of the carrier plate, the more length change shall be balanced by the adhesive. The openings, breakthroughs, slots and expansion joints in the carrier plate serve for venting the adhesive layer, so that the adhesive cures accordingly.

Additionally, a plurality of passage openings can be seen from FIGS. 3 and 4 or 9 and 10, via which correspondingly enclosed air can escape when adhering the carrier plate 10. A particularly homogeneous adhesive bed between the carrier plate 10 and the windshield 12 can thus be achieved by the passage openings 28.

An essentially trapezoidal recess 30 can be seen in both embodiments, via which the multi-purpose camera 18 can film to the outside through the carrier plate 10. The recesses 30 are thereby the face plate for the multi-purpose camera 18 and are thus formed correspondingly geometrically. The carrier plate 10 thus has not only the function of the holder of the different cameras or sensors 18 to 22, but also the function of a face plate for the multi-purpose camera 18. The recess 30 thereby comprises—as can be seen from FIGS. 4 and 10—a border 32, which is provided as a seal and which projects in an elevated manner with regard to the sides of the carrier plates 10 facing the windshield 12. The border 32 may be dimensioned in its elevated projecting height in such a manner that it is formed with the same height as the spacers 26 and thus abuts the arrangement of the carrier plate 10 to the windshield 12 with its surface facing inwardly. The border 32 thus serves as a dust seal, so that no dust can reach the region of the recess 30.

As can particularly be seen from FIGS. 3 and 5 or 9 and 11, the carrier plate 10 respectively comprises a carrier device 24, which comprises four carrying elements in the present case—two upper carrying elements 36 and two lower carrying elements 38—against which the multi-purpose camera 18 can be applied with a force directed in the direction of the vehicle interior or away from the carrier plate 10. This force is generated by a spring arrangement 40 with two spring elements 42 and 44. The carrier elements 36 and 38 thereby comprise a reference surface 46, against which a corresponding surface of the multi-surface camera 18 is pressed, which essentially cannot be seen.

It is thus ensured that the multi-purpose camera 18 is pressed evenly against the reference surfaces 46 of the carrier elements 36 or 38 by the force of the spring elements 42 and 44, so that a reproducible positioning of the multi-purpose camera 18 results, and with a small tolerance chain. The multi-purpose camera 18 can thereby be inserted into the carrier arrangement 34, in that this is inserted against the spring force of a further spring element 48, wherein this further spring element ensures that the used multi-purpose camera 18 is pressed against the lower carrying elements 38. An optimum positioning of the multi-purpose camera 18 is also achieved.

It can thus be seen that the MPC camera 18 is held in the end position in a play-free manner and with low tolerances by means of the springs 42, 44. For the trapezoidal region or the recess 30 of the plate 10 the following shall be stated: the lamination of the necessary distance of the viewing wedge to the black print—with tolerances—this region can be grooved, black or colored, so that one can not distinguish from the black print in this region from the outside.

At an outer side of the carrier plate 10 a further recess 50 can be seen, into which the rain and light sensor 20 is inserted.

A solder distributor can be seen above the recess 50 in FIGS. 2, 5 and 6.

Further, a pane heating module or a pane heater can be integrated in the region of the carrier plate 10, which ensures that no misting of the windshield can occur in the region of the cameras and the sensors 18 to 22.

It can further be seen from FIG. 8 that, in contrast to the embodiment according to FIG. 1—seen there particularly in FIG. 2—that the camera 22 is provided between the multi-purpose camera 12 and the rain sensor 20.

Correspondingly, it can be seen from FIGS. 9 and 10 that the carrier plate 10 according to the second embodiment has a further recess 54 for this camera 22, which possibly also serves as a face plate. In FIGS. 12 and 13, which show the cover 16 for the carrier device according to the second embodiment, it can be seen that a diffraction light face plate 56 is included. This diffraction light face plate 56 is correspodningly adapted to the recess 54 of the carrier plate 10 according to the second embodiment, so that a funnel-shaped element results altogether. The diffraction light face plate 56 according to FIGS. 12 and 13 is provided with a corresponding coating on the inside. The cover 16 thus not only has a protective function or cover function for the entire carrier device, but also has the further function of providing the diffraction light face plate 56.

Both embodiments further have in common that the respective covers—as can be seen from FIGS. 1 and 7—are provided with respective lamellar venting openings 58. The venting openings 58 can correspondingly be arranged offset to the inside in a resilient manner, in order to provide a larger adjustment region for an inner rear mirror arranged in the near region of the cover 16.

The respective cover 16 according to the first or the second embodiment is attached in an adjustable manner at the corresponding carrier plate 10 to be described in more detail below. This is particularly necessary in order to be able to balance a positioning of the carrier device or of the carrier plate 10 relative for example to the vehicle roof liner 14 caused by manufacture. In the present case, the adjustability is realized by respective guide elements 60 or 62. On sides of the carrier plate 16 respective guide rails 62 are provided, which altogether extend parallel to each other essentially in the longitudinal vehicle direction or into one direction. The cover 16 can be mounted onto these guide elements 62 with the interposition of its guide elements 60, which essentially have circular recesses 64, and can be displaced correspondingly along the rail-like guide elements. 62. Corresponding branch steps, toothings or the like can thereby be provided between the guide elements 60 and 62, so that the adjustment takes place in a stepped manner. A stepless adjustment is also conceivable. The guide elements 62 would have to be formed essentially smooth for this. It can be seen, however, that the guide elements 60, 62 on the side of the carrier plate 10 or the cover 16 create an adjustability of the cover, so that it can be adjusted in the longitudinal vehicle direction and parallel to the extension direction of the windshield 12. Manufacturing tolerances which develop, for example, when installing the windshield 12 can hereby be balanced, so that the cover 16 can for example be arranged flush with the vehicle roof liner 14. In FIG. 6, the arrangement of the carrier device can finally be seen from the outside of the motor vehicle. With the embodiment according to FIGS. 7 to 13, this is essentially identical, only that the corresponding recess 54 is provided for the further camera 22.

It can thus be seen from the figures that a plurality of elements are formed or can be formed to the carrier plate 10, as for example attachment elements for the camera 18, 22, attachment elements for the springs 42,44, clips for sensors 20, clips for contacting devices, clips for the heater, clips for a transport protection or dust protection, toothed clip bolts for the cap latching of the cover 16, expansion joints 24, YO markings or markings for the positioning at the windshield, spacers 26 and air guide webs, in order to guide the vehicle interior air quickly to the mist sensor. Metal guides or other plastic parts can also be injected into the carrier plate 10, in order to also be able to fix on the rain and light sensor 20 in a cost-efficient manner.

For the transport protection or for the dust-free transport, a transport protection that can be clipped out can be additionally clipped into the carrier plate. This can be clipped off again at the tape.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A carrier device for attaching to a windshield of a motor vehicle, having a carrier plate that can be attached to the windshield which is made of plastic at least in segments, and by which at least one of a camera and a sensor is carried,
wherein the plastic of the carrier plate is permeated with a glass additive material.

2. The carrier device according to claim 1, wherein the carrier plate comprises at least one expansion joint.

3. The carrier device according to claim 1, wherein the carrier plate has at least one spacer on the side facing the windshield.

4. The carrier device according to claim 1, wherein the carrier plate is permeated by at least one venting opening.

5. The carrier device according to claim 1, wherein the carrier plate has at least one recess, which is formed as a face plate for the associated camera.

6. The carrier device according to claim 5, wherein the recess of the carrier plate forming the face plate has a border, which projects in an elevated manner compared to the side of the carrier plate facing the windshield.

7. The carrier device according to claim 1, wherein the carrier plate has a carrying device serving as a stop, against which the at least one of the camera and the sensor are supported with a force directed from the carrier plate in the direction of the interior of the motor vehicle.

8. The carrier device according to claim 7, wherein the force supporting the at least one of the camera and the sensor against the carrying device is applied by a spring device arranged at the carrier plate.

9. The carrier device according to claim 1, wherein a cover is provided which covers the at least one of the camera and the sensor and which is arranged at the carrier plate in a relatively adjustable manner.

10. The carrier device according to claim 9, wherein cooperating carrying elements are provided at both components for adjusting the cover relative to the carrier plate, wherein the adjustment takes place in a stepped or stepless manner.

11. The carrier device according to claim 9, wherein the cover has a face plate.

12. The carrier device according to claim 11, wherein the cover is provided at least partially with a coating.

13. The carrier device according to claim 1, wherein a pane heater is integrated into the carrier plate, the pane heater heating at least one region of the windshield near the at least one of the camera and the sensor.

14. The carrier device according to claim 1, wherein the glass additive material is formed of glass reinforcing fibers.

15. The carrier device according to claim 1, wherein the glass additive material is formed of glass beads.

16. The carrier device according to claim 1, wherein the plastic is made of 10% to 40% of the glass additive material.

17. The carrier device according to claim 1, wherein the plastic is made of 20% to 30% of the glass additive material.
